(19) United States
(12) Patent Application Publication
(10) Pub. No.: US 2025/0029592 A1
(43) Pub. Date: Jan. 23, 2025

(54) ACTIVE NOISE REDUCTION SYSTEM

(71) Applicant: HONDA MOTOR CO., LTD., Tokyo (JP)

(72) Inventors: Xun WANG, Saitama (JP); Toshio INOUE, Saitama (JP)

(21) Appl. No.: 18/768,138

(22) Filed: Jul. 10, 2024

(30) Foreign Application Priority Data
Jul. 18, 2023 (JP) 2023-116790

(51) Int. Cl. G10K 11/178

(52) U.S. Cl. CPC G10K 11/1783

(57) ABSTRACT

An active noise reduction system includes a canceling sound output device configured to output a canceling sound for canceling a noise, an error microphone configured to generate an error signal based on the noise and the canceling sound, and a controller configured to control the canceling sound output device based on the error signal, wherein the controller is configured to calculate a canceling sound propagation distance that is a distance from the canceling sound output device to the error microphone, and suppress a change in the canceling sound based on the canceling sound propagation distance.

### TECHNICAL FIELD

The present invention relates to an active noise reduction system that reduces a noise by causing a canceling sound that is in an opposite phase to the noise to interfere with the noise.

### BACKGROUND ART

In recent years, taking into account people in vulnerable situations such as the elderly and children among traffic participants, efforts have been actively made to provide access to sustainable transportation systems for such people. Toward its realization, research and development for further improving the safety and convenience of traffic through development of vehicle comfort are attracting attention.

To improve vehicle comfort, it is desirable to reduce the noise inside a vehicle. As such, research and development of an active noise reduction system, which reduces the noise by causing a canceling sound that is in an opposite phase to the noise to interfere with the noise, are actively conducted.

Conventionally, an active noise reduction system includes a canceling sound output device (for example, a speaker) configured to output a canceling sound for canceling a noise, an error microphone configured to generate an error signal based on the noise and the canceling sound, and a controller configured to control the canceling sound output device based on the error signal (see JPH7-28474A).

In a case where either the canceling sound output device or the error microphone is provided in a movable portion in such an active noise reduction system, the distance (hereinafter referred to as “the canceling sound propagation distance”) from the canceling sound output device to the error microphone may increase as the movable portion moves. When the canceling sound propagation distance increases in this way, the controller causes the canceling sound output device to output a large canceling sound in order to sufficiently reduce the noise at the position of the error microphone, which is away from the canceling sound output device. However, when the canceling sound output device outputs a large canceling sound in a case where the ear of the user (for example, the occupant of the vehicle) is closer to the canceling sound output device than the error microphone, the noise reduction effect may be deteriorated at the ear position of the user or the noise may be amplified at the ear position of the user.

### SUMMARY OF THE INVENTION

In view of the above background, an object of the present invention is to prevent the noise reduction effect from being reduced at the ear position of the user and to prevent the noise from being amplified at the ear position of the user in a case where the canceling sound propagation distance is increased. Further, another object of the present invention is to contribute to the development of sustainable transportation systems.

To achieve such an object, one aspect of the present invention provides an active noise reduction system (1, 61, and 71) comprising: a canceling sound output device (21) configured to output a canceling sound for canceling a noise; an error microphone (22) configured to generate an error signal (e) based on the noise and the canceling sound; and a controller (23, 63, and 73) configured to control the canceling sound output device based on the error signal, wherein the controller is configured to calculate a canceling sound propagation distance (L) that is a distance from the canceling sound output device to the error microphone, and suppress a change in the canceling sound based on the canceling sound propagation distance.

According to this aspect, by suppressing a change in the canceling sound based on the canceling sound propagation distance, it is possible to suppress the increase in the canceling sound as the canceling sound propagation distance increases. Accordingly, it is possible to prevent the noise reduction effect from being reduced at the ear position of the user and to prevent the noise from being amplified at the ear position of the user.

In the above aspect, preferably, the controller includes: a control filter (W) configured to generate a control signal (u) for controlling the canceling sound output device; a primary path filter (H\hat{ }) that represents an estimation value of a transfer function from a noise source to the error microphone; and a secondary path filter (C\hat{ }) that represents an estimation value of a transfer function from the canceling sound output device to the error microphone, wherein the control filter is configured to be adaptively updated based on a virtual error signal (e₂) generated based on both a noise estimation signal (d\hat{ }) generated by the primary path filter and a canceling sound estimation signal (y\hat{ }₂) generated by the secondary path filter, and the controller is configured to correct at least one of the noise estimation signal or the canceling sound estimation signal according to the canceling sound propagation distance.

According to this aspect, by correcting the noise estimation signal or the canceling sound estimation signal used in the adaptive update of the control filter according to the canceling sound propagation distance, it is possible to prevent the control signal generated by the control filter from becoming excessively large.

In the above aspect, preferably, the controller is configured to set a gain coefficient (α) that increases as the canceling sound propagation distance increases, and correct the canceling sound estimation signal by multiplying the canceling sound estimation signal by the gain coefficient.

According to this aspect, it is possible to easily change the magnitude of the canceling sound estimation signal by adjusting the gain coefficient. Accordingly, it is possible to easily adjust the volume of the canceling sound.

In the above aspect, preferably, the controller is configured to set a gain coefficient (β) that decreases as the canceling sound propagation distance increases, and correct the noise estimation signal by multiplying the noise estimation signal by the gain coefficient.

According to this aspect, it is possible to easily change the magnitude of the noise estimation signal by adjusting the gain coefficient. Accordingly, it is possible to easily adjust the volume of the canceling sound.

In the above aspect, preferably, the controller is configured to calculate the canceling sound propagation distance based on the secondary path filter.

The secondary path filter represents an estimation value of a transfer function from the canceling sound output device to the error microphone. Accordingly, the canceling sound propagation distance, which is a distance from the canceling sound output device to the error microphone, can be calculated based on the secondary path filter. As the canceling sound propagation distance is calculated based on the secondary path filter, it is not necessary to provide a separate sensor and the like for calculating the canceling sound propagation distance. Accordingly, costs can be reduced.

In the above aspect, preferably, the secondary path filter is composed of a finite impulse response filter, and the controller is configured to calculate the canceling sound propagation distance based on a delay time from a first time to a second time, the first time being a time when the canceling sound output device outputs the canceling sound, the second time being a time when an amplitude of an impulse response of the secondary path filter becomes maximum.

According to this aspect, it is possible to easily calculate the canceling sound propagation distance based on the impulse response of the secondary path filter.

In the above aspect, preferably, the canceling sound output device is installed in an occupant seat (6) of a vehicle (3), the error microphone is installed in a portion of the vehicle other than the occupant seat, and the controller is configured to calculate the canceling sound propagation distance based on a position of the occupant seat.

In a case where the canceling sound output device is installed in the occupant seat and the error microphone is installed in a portion other than the occupant seat, the canceling sound propagation distance changes according to the change in the position of the occupant seat. In light of such a situation, the canceling sound propagation distance is calculated based on the position of the occupant seat. Accordingly, it is possible to easily calculate the canceling sound propagation distance without increasing the calculational load on the controller.

In the above aspect, preferably, the canceling sound output device is installed in a reclining portion (8) of the occupant seat, and the controller is configured to calculate the canceling sound propagation distance based on at least one of a front-and-rear position of the occupant seat, a height of the occupant seat, and an inclination angle of the reclining portion.

According to this aspect, it is possible to easily calculate the canceling sound propagation distance based on the above data in a case where the canceling sound output device is installed in the reclining portion that is close to the ear position of the occupant.

To achieve such an object, another aspect of the present invention provides an active noise reduction system (81 and 91) comprising: a canceling sound output device (21) configured to output a canceling sound for canceling a noise; an error microphone (22) configured to generate an error signal (e) based on the noise and the canceling sound; and a controller (83 and 93) configured to control the canceling sound output device based on the error signal, wherein the controller is configured to calculate a canceling sound propagation distance (L) that is a distance from the canceling sound output device to the error microphone, and cause the canceling sound output device to stop an output of the canceling sound in a case where the canceling sound propagation distance is equal to or greater than a prescribed threshold.

According to this aspect, in a case where the canceling sound propagation distance is equal to or greater than the threshold, the canceling sound output device stops an output of the canceling sound, which reliably prevents the noise from being amplified at the ear position of the user. Accordingly, it is possible to prevent the user from feeling uncomfortable about the canceling sound.

In the above aspect, preferably, the controller includes a secondary path filter (C\hat{ }) that represents an estimation value of a transfer function from the canceling sound output device to the error microphone, and the controller is configured to calculate the canceling sound propagation distance based on the secondary path filter.

The secondary path filter represents an estimation value of a transfer function from the canceling sound output device to the error microphone. Accordingly, the canceling sound propagation distance, which is a distance from the canceling sound output device to the error microphone, can be calculated based on the secondary path filter. As the canceling sound propagation distance is calculated based on the secondary path filter, it is not necessary to provide a separate sensor and the like for calculating the canceling sound propagation distance. Accordingly, costs can be reduced.

In the above aspect, preferably, the canceling sound output device is installed in an occupant seat (6) of a vehicle (3), the error microphone is installed in a portion of the vehicle other than the occupant seat, and the controller is configured to calculate the canceling sound propagation distance based on a position of the occupant seat.

In a case where the canceling sound output device is installed in the occupant seat and the error microphone is installed in a portion other than the occupant seat, the canceling sound propagation distance changes according to the change in the position of the occupant seat. In light of such a situation, the canceling sound propagation distance is calculated based on the position of the occupant seat. Accordingly, it is possible to easily calculate the canceling sound propagation distance without increasing the calculational load on the controller.

In the above aspect, preferably, the canceling sound output device is installed in an occupant seat (6) of a vehicle (3), and the controller is configured to cause the canceling sound output device to stop an output of the canceling sound upon receiving information that an occupant is not seated in the occupant seat.

According to this aspect, it is possible to prevent the canceling sound outputted from the canceling sound output device of one occupant seat where no occupant is seated from causing an occupant seated in another occupant seat to feel discomfort.

Thus, according to the above aspects, it is possible to prevent the noise reduction effect from being reduced at the ear position of the user and to prevent the noise from being amplified at the ear position of the user in a case where the canceling sound propagation distance is increased.

### BRIEF DESCRIPTION OF THE DRAWING(S)

FIG. 1 is a schematic diagram showing a vehicle to which an active noise reduction system according to the first embodiment is applied;

FIG. 2 is a functional block diagram showing the active noise reduction system according to the first embodiment;

FIG. 3 is a graph showing an impulse response of a secondary path filter according to the first embodiment;

FIG. 4 is a diagram showing a gain coefficient table according to the first embodiment;

FIG. 5 is a functional block diagram showing an active noise reduction system according to the second embodiment;

FIG. 6 is a diagram showing a gain coefficient table according to the second embodiment;

FIG. 7 is a functional block diagram showing an active noise reduction system according to the third embodiment;

FIG. 8 is a schematic diagram showing a coordinate system according to the third embodiment;

FIG. 9 is a functional block diagram showing an active noise reduction system according to the fourth embodiment;

FIG. 10 is a functional block diagram showing an active noise reduction system according to the fifth embodiment; and

FIG. 11 is a flowchart showing an update process according to the fifth embodiment.

### DETAILED DESCRIPTION OF THE INVENTION

In the following, embodiments of the present invention will be described with reference to the drawings. Note that in the following description, “\hat{ }” (circumflex) added to various symbols indicates an identified value or an estimated value. “\hat{ }” is added above each symbol in the drawings, but is added after each symbol in the description.

### The First Embodiment

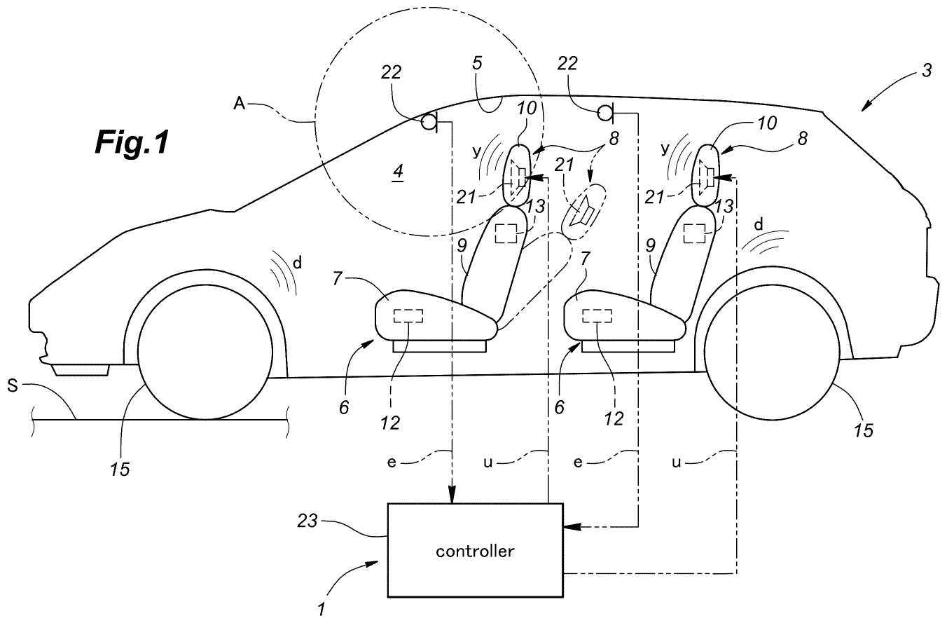

First, the first embodiment of the present invention will be described with reference to FIGS. 1 to 4.

### <Vehicle 3>

FIG. 1 is a schematic diagram showing a vehicle 3 to which an active noise reduction system 1 (hereinafter referred to as “the noise reduction system 1”) according to the first embodiment is applied. The vehicle 3 is, for example, a four-wheeled automobile.

Inside a vehicle cabin 4 of the vehicle 3, a plurality of occupant seats 6 is arranged below a roof lining 5. Each occupant seat 6 (hereinafter simply referred to as “the occupant seat 6”) includes a seat cushion 7 and a reclining portion 8 arranged above and behind the seat cushion 7 and configured to rotate relative to the seat cushion 7. The reclining portion 8 includes a seat back 9 and a headrest 10 fixed to an upper end of the seat back 9.

The front-and-rear position of the occupant seat 6 is adjusted by an electric motor (not shown) according to an operation on a position memory button (not shown) by an occupant (an example of a user). The inclination angle of the reclining portion 8 is adjusted by an electric motor (not shown) according to an operation on an adjustment lever (not shown) by the occupant. In other words, the occupant seat 6 is the so-called power seat. In another embodiment, not only the front-and-rear position of the occupant seat 6 and the inclination angle of the reclining portion 8 but also the height of the occupant seat 6 may be adjustable.

The occupant seat 6 is provided with a seating sensor 12 configured to detect whether the occupant is seated therein. The seating sensor 12 is, for example, a load sensor configured to detect the load on the seat cushion 7 of the occupant seat 6. The occupant seat 6 is provided with a seat belt sensor 13 configured to detect whether the occupant fastens a seat belt.

### <Noise Reduction System 1>

The noise reduction system 1 is an Active Noise Control device (ANC device) configured to reduce a noise d generated inside the vehicle cabin 4 of the vehicle 3. More specifically, the noise reduction system 1 reduces the noise d by generating a canceling sound y that is in an opposite phase to the noise d and causing the generated canceling sound y to interfere with the noise d.

For example, the noise d to be reduced by the noise reduction system 1 is a road noise caused by the vibrations of wheels 15 due to the force from a road surface S. The noise d to be reduced by the noise reduction system 1 may be a noise (for example, a drive noise caused by the vibrations of a drive source such as an internal combustion engine and an electric motor) other than the above-mentioned road noise.

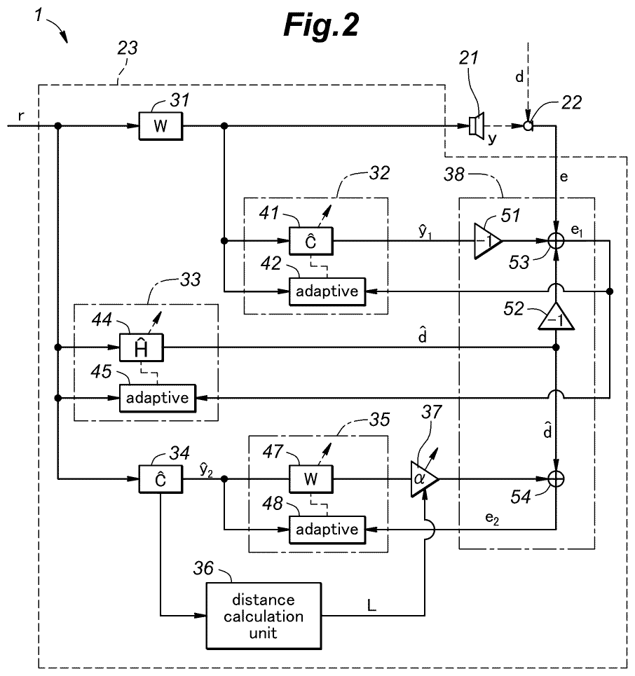

With reference to FIGS. 1 and 2, the noise reduction system 1 includes a plurality of speakers 21 (an example of a canceling sound output device) each configured to output the canceling sound y for canceling the noise d, a plurality of error microphones 22 each configured to generate an error signal e based on the noise d and the canceling sound y, and a controller 23 configured to control the plurality of speakers 21 based on the error signal e.

### <Speaker 21>

With reference to FIG. 1, each speaker 21 (hereinafter simply referred to as “the speaker 21”) is installed in the headrest 10 of the reclining portion 8 of the occupant seat 6. In another embodiment, the speaker 21 may be installed in a portion (for example, the seat back 9) other than the headrest 10 of the reclining portion 8 of the occupant seat 6, or in a portion other than the reclining portion 8 of the occupant seat 6. In still another embodiment, the speaker 21 may be installed in a portion of the vehicle 3 other than the occupant seat 6.

### <Error Microphone 22>

Each error microphone 22 (hereinafter, simply referred to as “the error microphone 22”) is installed in a portion of the vehicle 3 other than the occupant seat 6. The error microphone 22 is installed, for example, in the roof lining 5. In another embodiment, the error microphone 22 may be installed in a B-pillar (not shown) and the like, or in the occupant seat 6.

### <Controller 23>

The controller 23 is composed of a computer including an arithmetic processing unit (a processor such as a CPU, an MPU, etc.) and a storage device (a memory such as a ROM, a RAM, etc.). The controller 23 may be configured as one piece of hardware or may be configured as a unit including multiple pieces of hardware.

With reference to FIG. 2, the controller 23 includes, as functional components, a control signal generation unit 31, a first canceling sound estimation signal generation unit 32, a noise estimation signal generation unit 33, a second canceling sound estimation signal generation unit 34, a control filter update unit 35, a distance calculation unit 36, a signal correction unit 37, and a virtual error signal generation unit 38.

### <Control Signal Generation Unit 31>

The control signal generation unit 31 of the controller 23 includes a control filter W. The control filter W is composed of, for example, a finite impulse response filter (FIR filter). In another embodiment, the control filter W may be composed of a single-frequency adaptive notch filter (SAN filter) and the like.

A reference signal r corresponding to the noise d is input to the control signal generation unit 31. The reference signal r is input to the control signal generation unit 31, for example, from a reference microphone (not shown) that generates the reference signal r from the noise d. In another embodiment, the reference signal r may be input to the control signal generation unit 31 from a vibration sensor (not shown) that detects the vibrations corresponding to the noise d, or from a component other than the reference microphone or the vibration sensor.

As the control filter W of the control signal generation unit 31 filters the reference signal r, the control signal generation unit 31 generates a control signal u for controlling the speaker 21. The control signal generation unit 31 outputs the generated control signal u to the speaker 21 and the first canceling sound estimation signal generation unit 32. Accordingly, the speaker 21 generates the canceling sound y according to the control signal u output from the control signal generation unit 31.

### <First Canceling Sound Estimation Signal Generation Unit 32>

The first canceling sound estimation signal generation unit 32 of the controller 23 includes a secondary path filter unit 41 and a secondary path update unit 42.

The secondary path filter unit 41 includes a secondary path filter C\hat{ }. The secondary path filter C\hat{ } is a filter that represents an estimation value of a transfer function of the secondary path from the speaker 21 to the error microphone 22. The secondary path filter C\hat{ } is composed of, for example, an FIR filter. In another embodiment, the secondary path filter C\hat{ } may be composed of a SAN filter and the like.

As the secondary path filter C\hat{ } of the secondary path filter unit 41 filters the control signal u, the secondary path filter unit 41 generates a first canceling sound estimation signal y\hat{ }₁ that represents an estimation value of the canceling sound y. The secondary path filter unit 41 outputs the generated first canceling sound estimation signal y\hat{ }₁ to the virtual error signal generation unit 38.

The secondary path update unit 42 adaptively updates the secondary path filter C\hat{ } using an adaptive algorithm such as a least mean square algorithm (LMS algorithm). More specifically, the secondary path update unit 42 adaptively updates the secondary path filter C\hat{ } such that a first virtual error signal e₁ (which will be described later) output from the virtual error signal generation unit 38 is minimized.

### <Noise Estimation Signal Generation Unit 33>

The noise estimation signal generation unit 33 of the controller 23 includes a primary path filter unit 44 and a primary path update unit 45.

The primary path filter unit 44 includes a primary path filter H\hat{ }. The primary path filter H\hat{ } is a filter that represents an estimation value of a transfer function of a primary path from a noise source to the error microphone 22. The primary path filter H\hat{ } is composed of, for example, an FIR filter. In another embodiment, the primary path filter HA may be composed of a SAN filter and the like.

As the primary path filter H\hat{ } of the primary path filter unit 44 filters the reference signal r, the primary path filter unit 44 generates a noise estimation signal d\hat{ } that represents an estimation value of the noise d. The primary path filter unit 44 outputs the generated noise estimation signal d\hat{ } to the virtual error signal generation unit 38.

The primary path update unit 45 adaptively updates the primary path filter H\hat{ } using an adaptive algorithm such as the LMS algorithm. More specifically, the primary path update unit 45 adaptively updates the primary path filter H\hat{ } such that the first virtual error signal e₁ output from the virtual error signal generation unit 38 is minimized.

### <Second Canceling Sound Estimation Signal Generation Unit 34>

The second canceling sound estimation signal generation unit 34 of the controller 23 includes the secondary path filter C\hat{ }, similar to the first canceling sound estimation signal generation unit 32. When the secondary path filter C\hat{ } is updated in the first canceling sound estimation signal generation unit 32, the updated secondary path filter C\hat{ } is output to the second canceling sound estimation signal generation unit 34, and the secondary path filter C\hat{ } is updated in the second canceling sound estimation signal generation unit 34. That is, the secondary path filter C\hat{ } set in the second canceling sound estimation signal generation unit 34 is not a fixed value, but a value updated at any time based on the signal from the first canceling sound estimation signal generation unit 32.

As the secondary path filter C\hat{ } of the second canceling sound estimation signal generation unit 34 filters the reference signal r, the second canceling sound estimation signal generation unit 34 generates a second canceling sound estimation signal y\hat{ }₂ that represents an estimation value of the canceling sound y. The second canceling sound estimation signal generation unit 34 outputs the generated second canceling sound estimation signal y\hat{ }₂ to the control filter update unit 35.

### <Control Filter Update Unit 35>

The control filter update unit 35 of the controller 23 includes a control filter unit 47 and a control update unit 48.

The control filter unit 47, similar to the control signal generation unit 31, includes the control filter W. The control filter W of the control filter unit 47 filters the second canceling sound estimation signal y\hat{ }₂. The control filter unit 47 outputs the filtered second canceling sound estimation signal y\hat{ }₂ to the signal correction unit 37.

The control update unit 48 adaptively updates the control filter W of the control filter unit 47 using an adaptive algorithm such as the LMS algorithm. More specifically, the control update unit 48 adaptively updates the control filter W of the control filter unit 47 such that a second virtual error signal e₂ (which will be described later) output from the virtual error signal generation unit 38 is minimized.

When the control filter W is updated in the control filter update unit 35, the updated control filter W is output to the control signal generation unit 31, and the control filter W is updated in the control signal generation unit 31. That is, the control filter W set in the control signal generation unit 31 is not a fixed value, but a value updated at any time based on the signal from the control filter update unit 35.

### <Distance Calculation Unit 36>

The distance calculation unit 36 of the controller 23 calculates a canceling sound propagation distance L (hereinafter referred to as “the propagation distance L”) from the speaker 21 to the error microphone 22 based on the secondary path filter C\hat{ }included in the second canceling sound estimation signal generation unit 34. The distance calculation unit 36 outputs the calculated propagation distance L to the signal correction unit 37. The method for the distance calculation unit 36 to calculate the propagation distance L will be described later.

### <Signal Correction Unit 37>

The signal correction unit 37 of the controller 23 is provided between the control filter update unit 35 and the virtual error signal generation unit 38. The signal correction unit 37 has a gain coefficient α. The signal correction unit 37 corrects the second canceling sound estimation signal y\hat{ }₂ by multiplying the second canceling sound estimation signal y\hat{ }₂ by the gain coefficient α. The signal correction unit 37 outputs the corrected second canceling sound estimation signal y\hat{ }₂ to the virtual error signal generation unit 38. The method for the signal correction unit 37 to correct the second canceling sound estimation signal y\hat{ }₂ will be described later.

### <Virtual Error Signal Generation Unit 38>

The virtual error signal generation unit 38 of the controller 23 includes a first polarity reversing unit 51, a second polarity reversing unit 52, a first adder 53, and a second adder 54.

The first polarity reversing unit 51 reverses the polarity of the first canceling sound estimation signal y\hat{ }₁ output from the first canceling sound estimation signal generation unit 32. The second polarity reversing unit 52 reverses the polarity of the noise estimation signal d\hat{ } output from the noise estimation signal generation unit 33.

The first adder 53 generates the first virtual error signal e₁ by adding the error signal e output from the error microphone 22, the first canceling sound estimation signal y\hat{ }₁ that has passed through the first polarity reversing unit 51, and the noise estimation signal d\hat{ } that has passed through the second polarity reversing unit 52. The first adder 53 outputs the generated first virtual error signal e₁ to the first canceling sound estimation signal generation unit 32 and the noise estimation signal generation unit 33.

The second adder 54 generates the second virtual error signal e₂ by adding the noise estimation signal d\hat{ } output from the noise estimation signal generation unit 33 and the second canceling sound estimation signal y\hat{ }₂ output from the signal correction unit 37. The second adder 54 outputs the generated second virtual error signal e₂ to the control filter update unit 35.

### <The Calculation of the Propagation Distance L>

Next, the method for the distance calculation unit 36 to calculate the propagation distance L will be described.

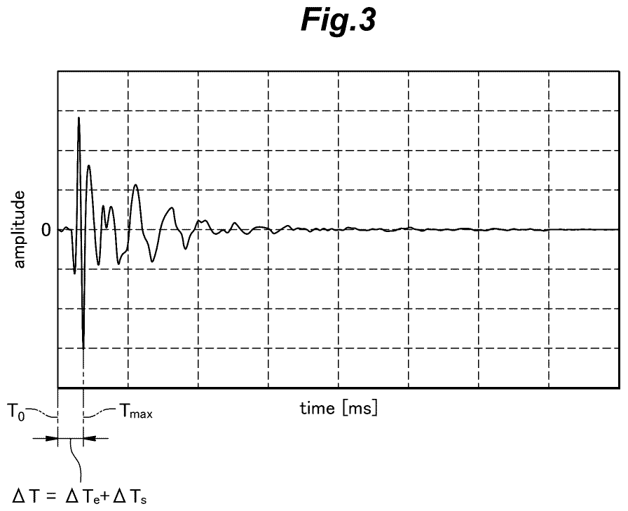

FIG. 3 shows an impulse response of the secondary path filter C\hat{ } included in the second canceling sound estimation signal generation unit 34. A second time Tₘₐₓ is delayed from a first time T₀ by a delay time ΔT. The first time T₀ is a time when the speaker 21 outputs the canceling sound y. The second time Tₘₐₓ is a time when the absolute value of the amplitude of the impulse response of the secondary path filter C\hat{ } (i.e., the coefficient of the secondary path filter C\hat{ }) becomes maximum. The delay time ΔT is represented by the following formula (1). In the following formula (1), “ΔTₑ” represents a processing time of an electronic circuit that constitutes the controller 23, and “ΔTₛ” represents a propagation time of the canceling sound y from the speaker 21 to the error microphone 22.

$$Δ T = Δ {T}_{e} + Δ {T}_{s} \qquad ( 1 )$$

On the other hand, the propagation distance L is represented by the following formula (2). In the following formula (2), “c” represents the speed (about 340 m/s) of the sound. In the following formula (2), “c” is a known value.

$$L = Δ {T}_{s} \times c \qquad ( 2 )$$

From the above formula (1) and formula (2), the following formula (3) is acquired. From the following formula (3), the following formula (4) is acquired. In the following formula (4), “nₘₐₓ” (hereinafter referred to as “the delay sample number nₘₐₓ”) represents the sample number corresponding to the delay time ΔT, “nₑ” represents the sample number corresponding to the processing time ΔTₑ of the electronic circuit that constitutes the controller 23, and “Tₛₐ” represents a sampling time. In the following formula (4), “nₑ” and “Tₛₐ” are known values.

$$L = ( Δ T - Δ {T}_{e} ) \times c \qquad ( 3 )$$

$$L = ( {n}_{max} - {n}_{e} ) \times {T}_{sa} \times c \qquad ( 4 )$$

The distance calculation unit 36 first identifies the delay sample number nₘₐₓ from the impulse response of the secondary path filter C\hat{ }. Next, the distance calculation unit 36 calculates the propagation distance L by substituting the identified delay sample number nₘₐₓ into the above formula (4). In this way, the distance calculation unit 36 calculates the propagation distance L based on the delay time ΔT (more specifically, the delay sample number nₘₐₓ corresponding to the delay time ΔT).

<The Correction of the Second Canceling Sound Estimation Signal y\hat{ }₂>

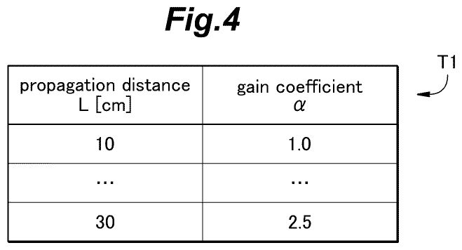

Next, the method for the signal correction unit 37 to correct the second canceling sound estimation signal y\hat{ }₂ will be described. With reference to FIG. 4, the signal correction unit 37 stores a gain coefficient table T1. The gain coefficient table T1 is a table defining the relationship between the propagation distance L and the gain coefficient α. The gain coefficient table T1 is set such that the gain coefficient α is 1 in a case where the propagation distance L is the minimum value (for example, 10 cm). The gain coefficient table T1 is set such that the gain coefficient a increases as the propagation distance L increases.

The signal correction unit 37 sets the gain coefficient a by referring to the gain coefficient table T1 based on the propagation distance L calculated by the distance calculation unit 36. For example, the signal correction unit 37 sets the gain coefficient a such that the gain coefficient α is 1 in a case where the propagation distance L is the minimum value and the gain coefficient α increases as the propagation distance L increases.

The signal correction unit 37 corrects the second canceling sound estimation signal y\hat{ }₂ according to the propagation distance L by multiplying the second canceling sound estimation signal y\hat{ }₂ by the gain coefficient α. As described above, in a case where the propagation distance L is the minimum value, the gain coefficient α is set to 1. Accordingly, even if the signal correction unit 37 multiplies the second canceling sound estimation signal y\hat{ }₂ by the gain coefficient α, the second canceling sound estimation signal y\hat{ }₂ does not increase or decrease.

On the other hand, in a case where the propagation distance L is greater than the minimum value, the gain coefficient α is set to a value greater than 1. Accordingly, when the signal correction unit 37 multiplies the second canceling sound estimation signal y\hat{ }₂ by the gain coefficient α, the second canceling sound estimation signal y\hat{ }₂ is amplified according to the propagation distance L. More specifically, as the propagation distance L increases, the gain coefficient α increases, and the amount of amplification of the second canceling sound estimation signal y\hat{ }₂ increases accordingly.

<The Suppression of the Change in the Canceling Sound y>

As described above, in a case where the propagation distance L is greater than the minimum value, as the signal correction unit 37 corrects the second canceling sound estimation signal y\hat{ }₂, the second canceling sound estimation signal y\hat{ }₂ is amplified according to the propagation distance L. Accordingly, the second canceling sound estimation signal y\hat{ }₂ becomes larger relative to the noise estimation signal d\hat{ }. Accordingly, the control update unit 48 adaptively updates the control filter W such that the second virtual error signal e₂ becomes smaller. Accordingly, the canceling sound y output from the speaker 21 becomes smaller than in a case where the signal correction unit 37 does not correct the second canceling sound estimation signal y\hat{ }₂ (that is, in a case where the canceling sound y increases as the propagation distance L increases), which suppresses the change in the canceling sound y according to the increase in the propagation distance L (that is, the changing amount of the canceling sound y according to the increase in the propagation distance L decreases). In this regard, “suppressing the change in the canceling sound y according to the increase (change) in the propagation distance L” includes both “reducing the changing amount of the volume of the canceling sound y according to the increase (change) in the propagation distance L” and “not changing the volume of the canceling sound y (i.e., keeping the volume of the canceling sound y constant) even if the propagation distance L increases (changes)”.

### <Effects>

With reference to FIG. 1, the speaker 21 is installed in the reclining portion 8 of the occupant seat 6, and the error microphone 22 is installed in a portion other than the occupant seat 6. When the reclining portion 8 reclines in such a configuration, the propagation distance L (the distance from the speaker 21 to the error microphone 22) increases (see two-dot chain lines in FIG. 1). When the propagation distance L increases in this way, the controller 23 causes the speaker 21 to output a large canceling sound y in order to sufficiently reduce the noise d at the position of the error microphone 22, which is away from the speaker 21.

However, in a case where the reclining portion 8 reclines as described above, the occupant's ear may be closer to the speaker 21 than the error microphone 22, and may be outside a noise reduction target area A around the error microphone 22. When the speaker 21 outputs a large canceling sound y in a state where the occupant's ear is outside the noise reduction target area A, the reduction effect of the noise d may be reduced at the ear position of the occupant, or the noise d may be amplified at the ear position of the occupant.

In light of such a situation, the controller 23 suppresses the change in the canceling sound y based on the propagation distance L. Accordingly, it is possible to suppress the canceling sound y from increasing as the propagation distance L increases. Accordingly, it is possible to prevent the reduction effect of the noise d from being reduced at the ear position of the occupant and to prevent the noise d from being amplified at the ear position of the occupant.

Further, it is possible to suppress the unnecessary change in the canceling sound y. Accordingly, it is possible to more effectively prevent the reduction effect of the noise d from being reduced at the ear position of the occupant.

Further, the controller 23 corrects the second canceling sound estimation signal y\hat{ }₂, which is used in the adaptive update of the control filter W, according to the propagation distance L. Accordingly, it is possible to prevent the control signal u generated by the control filter W from becoming excessively large.

### The Second Embodiment

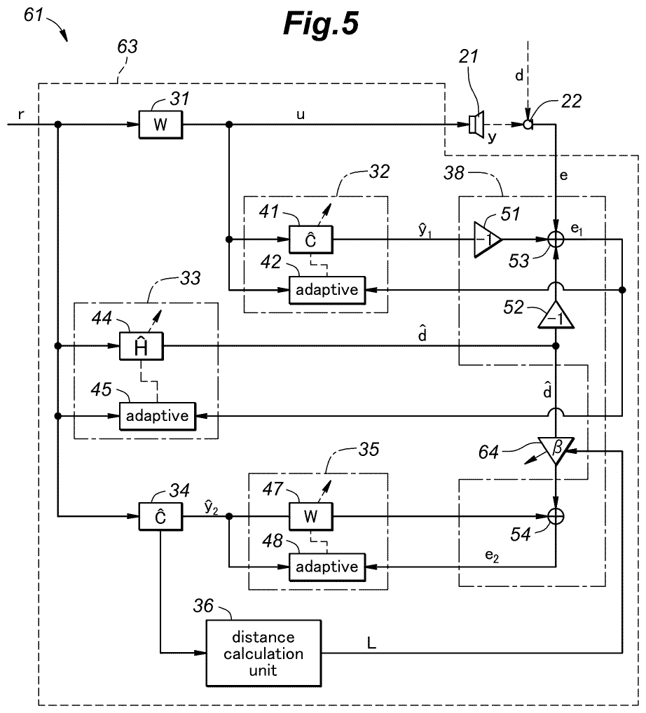

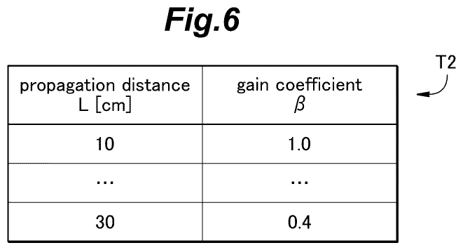

Next, with reference to FIGS. 5 and 6, an active noise reduction system 61 (hereinafter referred to as “the noise reduction system 61”) according to the second embodiment of the present invention will be described. The components other than a signal correction unit 64 of a controller 63 are the same as those in the first embodiment. Accordingly, the same reference numerals as in the first embodiment are given to these components in the drawings, and the descriptions thereof will be omitted.

### <Signal Correction Unit 64>

With reference to FIG. 5, the signal correction unit 64 of the controller 63 is provided between the noise estimation signal generation unit 33 and the virtual error signal generation unit 38. The signal correction unit 64 has a gain coefficient β. The signal correction unit 64 corrects the noise estimation signal d\hat{ } by multiplying the noise estimation signal d\hat{ } by the gain coefficient β. The signal correction unit 64 outputs the corrected noise estimation signal d\hat{ } to the virtual error signal generation unit 38.

With reference to FIG. 6, the signal correction unit 64 stores a gain coefficient table T2. The gain coefficient table T2 is a table defining the relationship between the propagation distance L and the gain coefficient β. The gain coefficient table T2 is set such that the gain coefficient β is 1 in a case where the propagation distance L is the minimum value (for example, 10 cm). The gain coefficient table T2 is set such that the gain coefficient β decreases as the propagation distance L increases.

The signal correction unit 64 sets the gain coefficient β by referring to the gain coefficient table T2 based on the propagation distance L calculated by the distance calculation unit 36. For example, the signal correction unit 64 sets the gain coefficient β such that the gain coefficient β is 1 in a case where the propagation distance L is the minimum value and the gain coefficient β decreases as the propagation distance L increases.

The signal correction unit 64 corrects the noise estimation signal d\hat{ }according to the propagation distance L by multiplying the noise estimation signal d\hat{ } by the gain coefficient β. As described above, in a case where the propagation distance L is the minimum value, the gain coefficient β is set to 1. Accordingly, even if the signal correction unit 64 multiplies the noise estimation signal d\hat{ } by the gain coefficient β, the noise estimation signal d\hat{ } does not increase or decrease.

On the other hand, in a case where the propagation distance L is greater than the minimum value, the gain coefficient β is set to a value smaller than 1. Accordingly, when the signal correction unit 64 multiplies the noise estimation signal d\hat{ } by the gain coefficient β, the noise estimation signal d\hat{ } is attenuated according to the propagation distance L. More specifically, as the propagation distance L increases, the gain coefficient β decreases, and the amount of attenuation of the noise estimation signal d\hat{ } increases accordingly.

<The Suppression of the Change in the Canceling Sound y>

As described above, in a case where the propagation distance L is greater than the minimum value, as the signal correction unit 64 corrects the noise estimation signal d\hat{ }, the noise estimation signal d\hat{ } is attenuated according to the propagation distance L. Accordingly, the second canceling sound estimation signal y\hat{ }₂ becomes larger relative to the noise estimation signal d\hat{ }. Accordingly, the control update unit 48 adaptively updates the control filter W such that the second virtual error signal e₂ becomes smaller. Accordingly, the canceling sound y output from the speaker 21 becomes smaller than in a case where the signal correction unit 64 does not correct the noise estimation signal d\hat{ } (that is, in a case where the canceling sound y increases as the propagation distance L increases), which suppresses the change in the canceling sound y according to the increase in the propagation distance L (that is, the changing amount of the canceling sound y according to the increase in the propagation distance L decreases).

### <Effects>

The controller 63 corrects the noise estimation signal d\hat{ }, which is used in the adaptive update of the control filter W, according to the propagation distance L. Accordingly, it is possible to prevent the control signal u generated by the control filter W from becoming excessively large.

### <Modifications>

In the first embodiment, the controller 23 corrects the second canceling sound estimation signal y\hat{ }₂ according to the propagation distance L. In the second embodiment, the controller 63 corrects the noise estimation signal d\hat{ } according to the propagation distance L. In another embodiment, the controller 23 or 63 may correct both the second canceling sound estimation signal y\hat{ }₂ and the noise estimation signal d\hat{ } according to the propagation distance L.

### The Third Embodiment

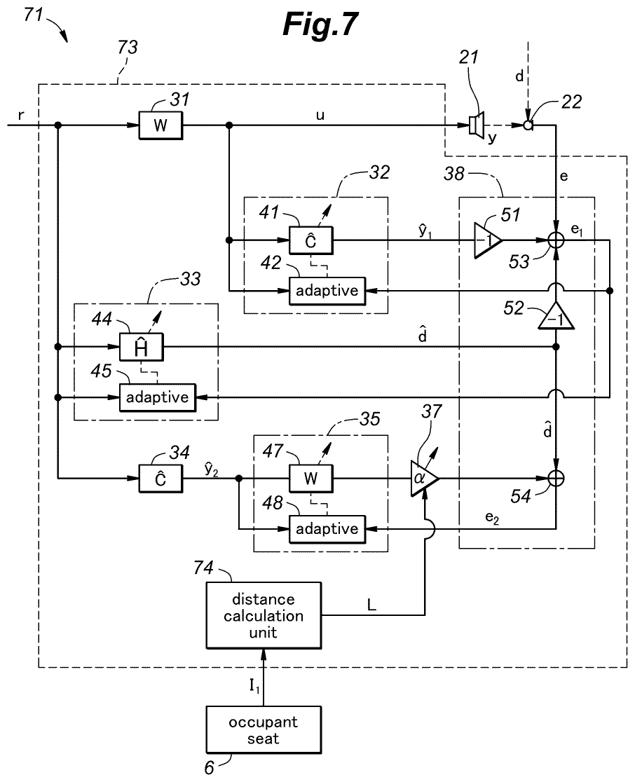

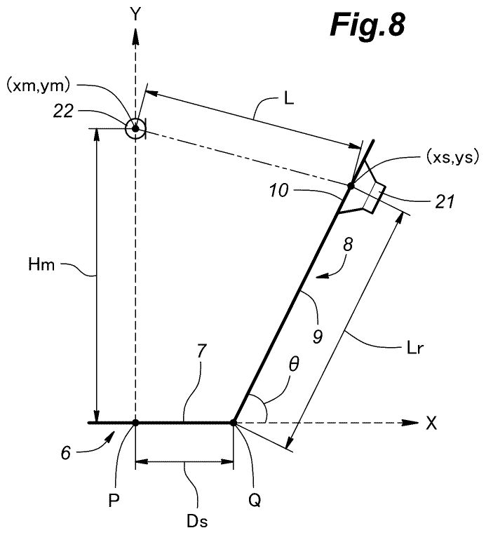

Next, with reference to FIGS. 7 and 8, an active noise reduction system 71 (hereinafter referred to as “the noise reduction system 71”) according to the third embodiment of the present invention will be described. The components other than a distance calculation unit 74 of a controller 73 are the same as those of the first embodiment. Accordingly, the same reference numerals as in the first embodiment are given to these components in the drawings, and the descriptions thereof will be omitted.

### <Distance Calculation Unit 74>

With reference to FIG. 7, seat position information I₁ is input from the occupant seat 6 to the distance calculation unit 74 of the controller 73. The seat position information I₁ includes the information about the front-and-rear position of the occupant seat 6 and the information about the inclination angle of the reclining portion 8 of the occupant seat 6. Preferably, the seat position information I₁ is updated when the above-mentioned position memory button or the adjustment lever (neither is shown) is operated.

The distance calculation unit 74 calculates the propagation distance L based on the seat position information I₁ input from the occupant seat 6. The method for the distance calculation unit 74 to calculate the propagation distance L will be described later.

FIG. 8 shows a coordinate system for calculating the propagation distance L. In this coordinate system, a point right below the error microphone 22 and at the same height as the seat cushion 7 is set as an origin P. Further, in this coordinate system, an X-axis is set horizontally rearward from the origin P, and a Y-axis is set vertically upward from the origin P.

In this coordinate system, the coordinate (xm, ym) of the error microphone 22 is acquired by the following formula (5). In the following formula (5), “Hm” represents a vertical distance from the seat cushion 7 to the error microphone 22. In the present embodiment, since the height of the occupant seat 6 does not change, “Hm” in the following formula (5) is a known value.

(xm, ym)=(0, Hm) (5)

In the above coordinate system, the coordinate (xs, ys) of the speaker 21 is acquired by the following formula (6). In the following formula (6), “Ds” represents a distance from the origin P to a rotation center Q (a rear end of the seat cushion 7) of the reclining portion 8, “Lr” represents a distance from the rotation center Q of the reclining portion 8 to the speaker 21, and “θ” represents an angle between the reclining portion 8 and the horizontal direction. “Lr” in the following formula (6) is a known value.

$$( xs , ys ) = ( Ds + Lr \times cos θ , Lr \times sin θ ) \qquad ( 6 )$$

From the above formula (5) and formula (6), the following formula (7) is acquired.

$$L = \sqrt{{( xs - xm )}^{2} + {( ys - ym )}^{2}} = \sqrt{{( Ds + Lr \times cos θ )}^{2} + {( Lr \times sin θ - Hm )}^{2}} \qquad ( 7 )$$

The distance calculation unit 74 calculates the distance Ds based on the seat position information I₁ (more specifically, the information about the front-and-rear position of the occupant seat 6). The distance calculation unit 74 acquires the angle 0 based on the seat position information I₁ (more specifically, the information about the inclination angle of the reclining portion 8 of the occupant seat 6). The distance calculation unit 74 calculates the propagation distance L by substituting the distance Ds and the angle θ into the above formula (7).

### <Effects>

The controller 73 calculates the propagation distance L based on the position of the occupant seat 6. Accordingly, it is possible to easily calculate the propagation distance L without increasing the calculation load on the controller 73.

### <Modifications>

In the third embodiment, similar to the first embodiment, the signal correction unit 37 corrects the second canceling sound estimation signal y\hat{ }₂. In another embodiment, similar to the second embodiment, the signal correction unit 37 may correct the noise estimation signal \hat{d}. Additionally, in still another embodiment, the signal correction unit 37 may correct both the second canceling sound estimation signal y\hat{ }₂ and the noise estimation signal d\hat{ }.

In the third embodiment, the distance calculation unit 74 calculates the propagation distance L using the coordinate system in which the origin P is a point right below the error microphone 22. In another embodiment, the distance calculation unit 74 may calculate the propagation distance L using a coordinate system different from the above coordinate system (for example, using a coordinate system in which the origin P is a point other than the point right below the error microphone 22).

In the third embodiment, the distance calculation unit 74 calculates the propagation distance L based on the front-and-rear position of the occupant seat 6 and the inclination angle of the reclining portion 8. In another embodiment, in a case where the height of the occupant seat 6 changes, the distance calculation unit 74 may calculate the propagation distance L based on the front-and-rear position of the occupant seat 6, the height of the occupant seat 6, and the inclination angle of the reclining portion 8. Additionally, in still another embodiment, the distance calculation unit 74 may calculate the propagation distance L based on only one of the front-and-rear position of the occupant seat 6, the height of the occupant seat 6, and the inclination angle of the reclining portion 8. In other words, the distance calculation unit 74 may calculate the propagation distance L based on at least one of the front-and-rear position of the occupant seat 6, the height of the occupant seat 6, and the inclination angle of the reclining portion 8.

### The Fourth Embodiment

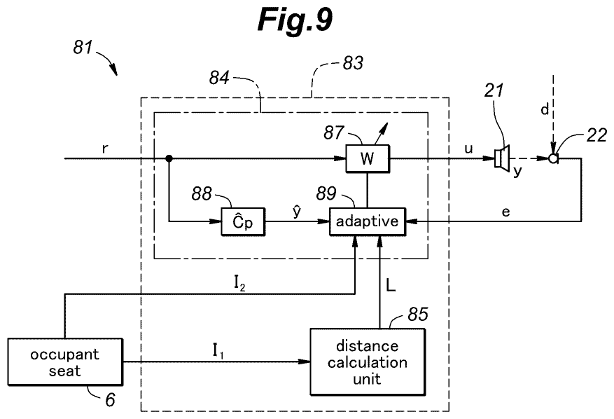

Next, with reference to FIG. 9, an active noise reduction system 81 (hereinafter referred to as “the noise reduction system 81”) according to the fourth embodiment of the present invention will be described. The components other than a controller 83 are the same as those in the first embodiment. Accordingly, the same reference numerals as in the first embodiment are given to these components in the drawings, and the descriptions thereof will be omitted. As for the controller 83, the descriptions that duplicate those in the first embodiment will be omitted.

### <Controller 83>

The controller 83 includes, as functional components, a control signal generation unit 84 and a distance calculation unit 85. The distance calculation unit 85 is similar to the distance calculation unit 74 according to the third embodiment, and therefore the descriptions thereof will be omitted.

### <Control Signal Generation Unit 84>

The control signal generation unit 84 of the controller 83 includes a control filter unit 87, a secondary path filter unit 88, and a control update unit 89.

The control filter unit 87 includes a control filter W. The control filter W is composed of an FIR filter. In another embodiment, the control filter W may be composed of a SAN filter and the like.

As the control filter W of the control filter unit 87 filters the reference signal r, the control filter unit 87 generates a control signal u. The control filter unit 87 outputs the generated control signal u to the speaker 21. Accordingly, the speaker 21 generates a canceling sound y according to the control signal u output from the control filter unit 87.

The secondary path filter unit 88 includes a secondary path filter C\hat{ }p. The secondary path filter C\hat{ }p is a filter that represents an estimation value of a transfer function of the secondary path from the speaker 21 to the error microphone 22. The secondary path filter C\hat{ }p is composed of an FIR filter. In another embodiment, the secondary path filter C\hat{ }p may be composed of a SAN filter and the like. The secondary path filter C\hat{ }p is a fixed value.

As the secondary path filter C\hat{ }p of the secondary path filter unit 88 filters the reference signal r, the secondary path filter unit 88 generates a canceling sound estimation signal y\hat{ } that represents an estimation value of the canceling sound y. The secondary path filter unit 88 outputs the generated canceling sound estimation signal y\hat{ } to the control update unit 89.

The control update unit 89 adaptively updates the control filter W using an adaptive algorithm such as the LMS algorithm. More specifically, the control update unit 89 updates the control filter W such that an error signal e output from the error microphone 22 is minimized.

<Stop/Continuation of the Output of the Canceling Sound y>

The distance calculation unit 85 calculates the propagation distance L based on the seat position information I₁ input from the occupant seat 6. The distance calculation unit 85 outputs the calculated propagation distance L to the control update unit 89.

In a case where the propagation distance L is equal to or greater than the prescribed threshold Lt, the control update unit 89 stops the adaptive update of the control filter W using the adaptive algorithm. Further, the control update unit 89 sets the coefficient of the control filter W to zero after gradually reducing the coefficient of the control filter W by updating the control filter W according to the following formula (8).

$$W ( t + 1 ) = η W ( t ) , η < 1 \qquad ( 8 )$$

Accordingly, the output of the canceling sound y from the speaker 21 stops after the canceling sound y output from the speaker 21 is gradually attenuated.

On the other hand, in a case where the propagation distance L is less than the threshold Lt, the control update unit 89 continues the adaptive update of the control filter W using the adaptive algorithm. Accordingly, the output of the canceling sound y from the speaker 21 continues.

The control update unit 89 receives seating information I₂ from the seating sensor 12 of the occupant seat 6. The seating information I₂ is the information indicating whether the occupant is seated in the occupant seat 6.

Upon receiving the seating information I₂ indicating that the occupant is not seated in the occupant seat 6 from the seating sensor 12, the control update unit 89 stops the adaptive update of the control filter W, and causes the speaker 21 to stop the output of the canceling sound y, similar to a case where the propagation distance L is equal to or greater than the threshold Lt.

On the other hand, upon receiving the seating information I₂ indicating that the occupant is seated in the occupant seat 6 from the seating sensor 12, the control update unit 89 continues the adaptive update of the control filter W, and causes the speaker 21 to continue the output of the canceling sound y, similar to a case where the propagation distance L is less than the threshold Lt.

### <Effects>

In a case where the propagation distance L is equal to or greater than the threshold Lt, the controller 83 causes the speaker 21 to stop the output of the canceling sound y. Accordingly, it is possible to reliably prevent the noise d from being amplified at the ear position of the occupant. Accordingly, it is possible to prevent the occupant from feeling uncomfortable about the canceling sound y.

In particular, in the present embodiment, the secondary path filter C\hat{ }p is a fixed value, and is not updated according to the change in the acoustic characteristic inside the vehicle cabin 4. Accordingly, the noise d is likely to be amplified at the ear position of the occupant. As such, the effect of suppressing the amplification of the noise d at the ear position of the occupant is remarkable as the output of the canceling sound y from the speaker 21 is stopped.

### <Modifications>

In the fourth embodiment, the control update unit 89 determines whether to cause the speaker 21 to stop the output of the canceling sound y based only on the information from the seating sensor 12. In another embodiment, the control update unit 89 may determine whether to cause the speaker 21 to stop the output of the canceling sound y based on both the information from the seating sensor 12 and the information from the seat belt sensor 13. For example, in a case where the control update unit 89 receives the information that the occupant is seated in the occupant seat 6 from the seating sensor 12 and receives the information that the occupant fastens the seat belt from the seat belt sensor 13, the control update unit 89 may cause the speaker 21 to continue the output of the canceling sound y. Otherwise, the control update unit 89 may cause the speaker 21 to stop the output of the canceling sound y. Accordingly, it is possible to prevent the speaker 21 from continuing the output of the canceling sound y in a case where the seating sensor 12 erroneously detects that the occupant is seated in the occupant seat 6 (for example, in a case where heavy luggage is put on the occupant seat 6).

Furthermore, in another embodiment, the control update unit 89 may determine whether to cause the speaker 21 to stop the output of the canceling sound y based on the information from an onboard monitoring camera (not shown) configured to capture the image of the occupant.

In the fourth embodiment, the above configuration (that is, the configuration to cause the speaker 21 to stop the output of the canceling sound y in a case where the information that the occupant is not seated in the occupant seat 6 is received) is applied to the noise reduction system 81 where the secondary path filter C\hat{ }p is a fixed value. In another embodiment, the above configuration may be applied to a noise reduction system (for example, the noise reduction system 1, 61, and 71 according to the first to third embodiments) where the secondary path filter C\hat{ } is adaptively updated.

### The Fifth Embodiment

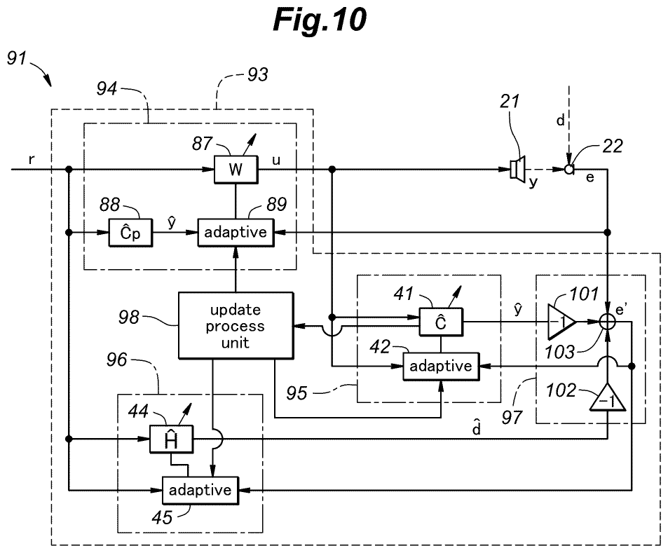

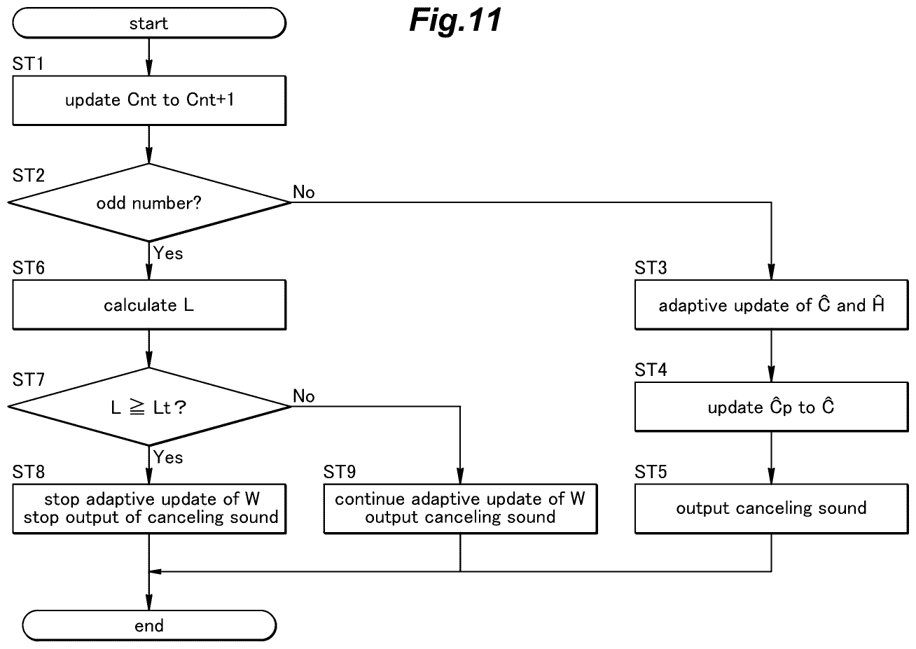

Next, with reference to FIGS. 10 and 11, an active noise reduction system 91 (hereinafter referred to as “the noise reduction system 91”) according to the fifth embodiment of the present invention will be described. The components other than a controller 93 are the same as those in the first embodiment. Accordingly, the same reference numerals as in the first embodiment are given to these components in the drawings, and the descriptions thereof will be omitted. As for the controller 93, the descriptions that duplicate those in the first embodiment will be omitted.

With reference to FIG. 10, the controller 93 includes, as functional components, a control signal generation unit 94, a canceling sound estimation signal generation unit 95, a noise estimation signal generation unit 96, a virtual error signal generation unit 97, and an update process unit 98. The components of the control signal generation unit 94 are similar to the components of the control signal generation unit 84 according to the fourth embodiment. Accordingly, the same reference numerals as in the fourth embodiment are given to these components in the drawings, and the descriptions thereof will be omitted. The components of the canceling sound estimation signal generation unit 95 and the noise estimation signal generation unit 96 are similar to the components of the first canceling sound estimation signal generation unit 32 and the noise estimation signal generation unit 33 according to the first embodiment. Accordingly, the same reference numerals as in the first embodiment are given to these components in the drawings, and the descriptions thereof will be omitted.

### <Virtual Error Signal Generation Unit 97>

The virtual error signal generation unit 97 of the controller 93 includes a first polarity reversing unit 101, a second polarity reversing unit 102, and an adder 103.

The first polarity reversing unit 101 reverses the polarity of the canceling sound estimation signal y\hat{ } output from the canceling sound estimation signal generation unit 95. The second polarity reversing unit 102 reverses the polarity of the noise estimation signal d\hat{ } output from the noise estimation signal generation unit 96.

The adder 103 generates a virtual error signal e′ by adding the error signal e, the canceling sound estimation signal y\hat{ } that has passed through the first polarity reversing unit 101, and the noise estimation signal d\hat{ } that has passed through the second polarity reversing unit 102. The adder 103 outputs the generated virtual error signal e′ to the canceling sound estimation signal generation unit 95 and the noise estimation signal generation unit 96.

### <Update Process Unit 98>

The update process unit 98 of the controller 93 performs an update process to update updatable filters (in the present embodiment, the control filter W, the secondary path filter C\hat{ }p, the secondary path filter C\hat{ }, and the primary path filter H\hat{ }). The update process unit 98 may repeatedly perform the update process at prescribed time intervals. In the following, the update process will be described in detail.

### <Update Process>

With reference to FIG. 11, when the update process is started, the update process unit 98 updates the number of times Cnt (initial value=0) of the update process to Cnt+1 (step ST1).

Next, the update process unit 98 determines whether the number of times Cnt is an odd number (step ST2). In a case where the number of times Cnt is an even number (step ST2: No), the update process unit 98 causes the secondary path update unit 42 to adaptively update the secondary path filter C\hat{ }, and causes the primary path update unit 45 to adaptively update the primary path filter H\hat{ } (step ST3).

Next, the update process unit 98 updates the secondary path filter C\hat{ }p to C\hat{ } by copying the secondary path filter C\hat{ } adaptively updated in step ST3 to the secondary path filter C\hat{ }p (step ST4). Next, the temporarily fixed control filter W (the control filter W updated in the previous update process) of the control filter unit 87 generates a control signal u, and the control filter unit 87 outputs the generated control signal u to the speaker 21. Accordingly, the speaker 21 outputs a canceling sound y (step ST5).

In a case where the number of times Cnt is an odd number (step ST2: Yes), the update process unit 98 calculates the propagation distance L based on the secondary path filter C\hat{ } (step ST6). The method for the update process unit 98 to calculate the propagation distance L is similar to the method for the distance calculation unit 36 to calculate the propagation distance L in the first embodiment. Accordingly, the descriptions thereof will be omitted.

Next, the update process unit 98 determines whether the propagation distance L is equal to or greater than the prescribed threshold Lt (step ST7). In a case where the propagation distance L is equal to or greater than the prescribed threshold Lt (step ST7: Yes), the update process unit 98 causes the control update unit 89 to stop the adaptive update of the control filter W, and causes the speaker 21 to stop the output of the canceling sound y (step ST8).

In a case where the propagation distance L is less than the threshold Lt (step ST7: No), the update process unit 98 causes the control update unit 89 to continue the adaptive update of the control filter W. The adaptively updated control filter W of the control filter unit 87 generates the control signal u, and the control filter unit 87 outputs the generated control signal u to the speaker 21. Accordingly, the speaker 21 outputs the canceling sound y (step ST9).

As any one of step ST5, step ST8, and step ST9 ends, the update process ends, and a new update process is performed after a prescribed time. However, the value of the number of times Cnt is maintained even after the end of the update process, and is used for the new update process.

### <Effects>

Similar to the fourth embodiment, the controller 93 causes the speaker 21 to stop the output of the canceling sound y in a case where the propagation distance L is equal to or greater than the threshold Lt. Accordingly, it is possible to reliably prevent the noise d from being amplified at the ear position of the occupant. Accordingly, it is possible to prevent the occupant from feeling uncomfortable about the canceling sound y. Further, as the adaptively updated secondary path filter C\hat{ } is copied to the secondary path filter C\hat{ }p, the secondary path filter C\hat{ }p always has a correct value. Accordingly, even if the occupant seat 6 moves in a state where the propagation distance L is less than the threshold Lt, the noise can be reduced in a more stable manner and to the maximum extent. Furthermore, learning of the sound field and the noise control are performed alternately. Accordingly, it is possible to calculate the propagation distance L based on the secondary path filter C\hat{ } and determine whether the propagation distance L is equal to or greater than the threshold Lt without significantly increasing the calculational load.

### <Modifications>

In the above first to fifth embodiments, the noise reduction system 1, 61, 71, 81, and 91 is applied to the vehicle cabin 4 of the vehicle 3. In another embodiment, the noise reduction system 1, 61, 71, 81, and 91 may be applied to an interior space of a moving body (for example, a ship or an aircraft) other than the vehicle 3, or to an interior space of a fixed object (for example, a house).

Concrete embodiments of the present invention have been described in the foregoing, but the present invention should not be limited by the foregoing embodiments and various modifications and alterations are possible within the scope of the present invention.

1. An active noise reduction system, comprising:
a canceling sound output device configured to output a canceling sound for canceling a noise;
an error microphone configured to generate an error signal based on the noise and the canceling sound; and
a controller configured to control the canceling sound output device based on the error signal,
wherein the controller is configured to
calculate a canceling sound propagation distance that is a distance from the canceling sound output device to the error microphone, and
suppress a change in the canceling sound based on the canceling sound propagation distance.

2. The active noise reduction system according to claim 1, wherein the controller includes:
a control filter configured to generate a control signal for controlling the canceling sound output device;
a primary path filter that represents an estimation value of a transfer function from a noise source to the error microphone; and
a secondary path filter that represents an estimation value of a transfer function from the canceling sound output device to the error microphone,
wherein the control filter is configured to be adaptively updated based on a virtual error signal generated based on both a noise estimation signal generated by the primary path filter and a canceling sound estimation signal generated by the secondary path filter, and
the controller is configured to correct at least one of the noise estimation signal or the canceling sound estimation signal according to the canceling sound propagation distance.

3. The active noise reduction system according to claim 2, wherein the controller is configured to
set a gain coefficient that increases as the canceling sound propagation distance increases, and
correct the canceling sound estimation signal by multiplying the canceling sound estimation signal by the gain coefficient.

4. The active noise reduction system according to claim 2, wherein the controller is configured to
set a gain coefficient that decreases as the canceling sound propagation distance increases, and
correct the noise estimation signal by multiplying the noise estimation signal by the gain coefficient.

5. The active noise reduction system according to claim 2, wherein the controller is configured to calculate the canceling sound propagation distance based on the secondary path filter.

6. The active noise reduction system according to claim 5, wherein the secondary path filter is composed of a finite impulse response filter, and
the controller is configured to calculate the canceling sound propagation distance based on a delay time from a first time to a second time, the first time being a time when the canceling sound output device outputs the canceling sound, the second time being a time when an amplitude of an impulse response of the secondary path filter becomes maximum.

7. The active noise reduction system according to claim 1, wherein the canceling sound output device is installed in an occupant seat of a vehicle,
the error microphone is installed in a portion of the vehicle other than the occupant seat, and
the controller is configured to calculate the canceling sound propagation distance based on a position of the occupant seat.

8. The active noise reduction system according to claim 7, wherein the canceling sound output device is installed in a reclining portion of the occupant seat, and
the controller is configured to calculate the canceling sound propagation distance based on at least one of a front-and-rear position of the occupant seat, a height of the occupant seat, and an inclination angle of the reclining portion.

9. An active noise reduction system, comprising:
a canceling sound output device configured to output a canceling sound for canceling a noise;
an error microphone configured to generate an error signal based on the noise and the canceling sound; and
a controller configured to control the canceling sound output device based on the error signal,
wherein the controller is configured to
calculate a canceling sound propagation distance that is a distance from the canceling sound output device to the error microphone, and
cause the canceling sound output device to stop an output of the canceling sound in a case where the canceling sound propagation distance is equal to or greater than a prescribed threshold.

10. The active noise reduction system according to claim 9, wherein the controller includes a secondary path filter that represents an estimation value of a transfer function from the canceling sound output device to the error microphone, and
the controller is configured to calculate the canceling sound propagation distance based on the secondary path filter.

11. The active noise reduction system according to claim 9, wherein the canceling sound output device is installed in an occupant seat of a vehicle,
the error microphone is installed in a portion of the vehicle other than the occupant seat, and
the controller is configured to calculate the canceling sound propagation distance based on a position of the occupant seat.

12. The active noise reduction system according to claim 1, wherein the canceling sound output device is installed in an occupant seat of a vehicle, and
the controller is configured to cause the canceling sound output device to stop an output of the canceling sound upon receiving information that an occupant is not seated in the occupant seat.

13. The active noise reduction system according to claim 9, wherein the canceling sound output device is installed in an occupant seat of a vehicle, and
the controller is configured to cause the canceling sound output device to stop an output of the canceling sound upon receiving information that an occupant is not seated in the occupant seat.
